(19) United States
(12) Patent Application Publication
(10) Pub. No.: US 2004/0148142 A1
(43) Pub. Date: Jul. 29, 2004

(54) GPS (Global Peak current Searching) Algorithm based on Gate-Level Power Analysis

(76) Inventor: Andy Huang, San Jose, CA (US)

Correspondence Address: ANDY HUANG, 2880 ZANKER ROAD, SUITE 203, SAN JOSE, CA, 95134, US

(21) Appl. No.: 10/248,684

(22) Filed: Feb. 7, 2003

Related U.S. Application Data
(60) Provisional application No. 60/319,227, filed on May 3, 2002.

(51) Int. Cl. G06F 17/10

(52) U.S. Cl. 703/2

(57) ABSTRACT

Detecting power and IR-drop is indispensable design process because todays circuits are very power and timing critical. Many approaches provide good solutions for average power consumption and average IR-drop. However, there are few methods in detecting peak power and peak IR-drop. Obviously, peak power and IR-drop are more informative to know real working behavior of a chip than average power and IR-drop. Unfortunately, detection of peak power(current) of a system uses time-consuming process employing normal power calculation for small time regions. This patent suggests a high-speed method with linear complexity for detecting the peak power regions. Once we know peak regions, we can analyze those regions in details.

### CROSS REFERENCE TO RELATED APPLICATIONS

Ghosh, S. Devades, K. Keutzer, and J. White, “Estimation of Average Switching Activity in Combinational and Sequential Circuits”, Proc. of the 29 DAC, pp. 253-259, June 1992. R. Marchulescu, D. Marculescu and M. Pedram, “Switching Activity Analysis Considering Spatiotemporal Correlations”, Proc. of ICCAD, 1994.

### BACKGROUND OF INVENTION

A lot of recent VLSI applications are getting larger and faster. Among them, the mobile systems require lower power as more functions are integrated into the system. Generally, the methods to build the low power system are controlling the threshold voltage, or reducing the supply voltage. However, the low power system results in lowering of speed and decreasing the noise immunity, which debases the reliability of the systems.

IR-drop analysis and power (or current) estimation of the design are the major activities for the low power system. Conventionally, the current and IR drop estimation can be obtained with the circuit simulators such as spice simulator, HSIM, PowerMill, etc. But the problems of estimation lie in the capacity and performance of circuit-level simulators. The circuit level simulators cannot perform the VLSI design if it has more than tens of thousands of transistors. Even though they can provide accurate analysis, these cannot do full-chip simulation. It takes so much time to simulate SoC full-chip that it cannot be applied to analyzing the recent SoC designs. This is why gate-level power estimation is more acceptable than transistor-level for analyzing SoC design.

In gate-level power estimation, probabilistic methods seemed efficient if we did not consider correlation among signals in the design. Since these techniques treated only density of the transition, we could get only the average value of the power consumption, not any peak one. Instead of the probabilistic method, the switching information of gate-level simulator is applied to the power analysis. The conventional IR-drop analyzers such as VoltageStorm-SoC and Astro-Rail use the result of logic simulator.

The development of power estimation technique at gate level gives great help to predict the average power consumption of system, because it provides useful accurate information, which is less than 10% error compared with silicon measurement. Although the average value is very meaningful to know about the thermal effect, EM (Electo-Migration) phenomenon, and the required PAD counts, but the peak current of system and IR-drop at the net of component are dominant factors to determine the exact timing violation at the VDSM.

There is a simple technique to get the peak value of the power; dividing the simulation periods into pieces and performing power estimation. However, these values are merely the average currents of pieces of simulation periods, and we might miss the peak current value caused by consecutive events. Moreover, this method requires long CPU time because iterative power calculations are CPU intensive process. There are few researches to predict the peak system power and regions until now.

### BRIEF DESCRIPTIONS OF DRAWINGS

FIG. 1. The example of energy weight for a signal

FIG. 2. The example of the GPS(Global Peak Algorithm).

### DETAILED DESCRIPTION

### 1. Definition of Energy Weight for Signal

The energy weight of a signal, e_{signal} is defined by total energy to make a signal transition: normally there are six transitions(0→x/z, 0→1, 1→x/z, 1→0, x/z→0, x/z→1)) in gate-level simulation. Our general energy weight equation of a signal is

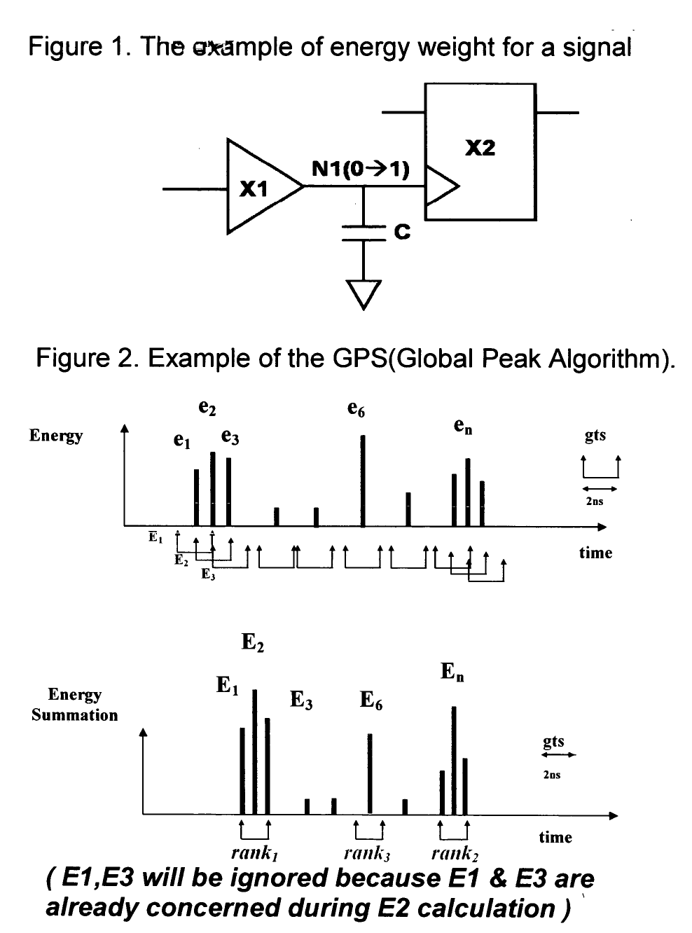

e_{signal}=eₙₑₜ+e_{driver}+e_{driven}

where eₙₑₜ is charging energy of capacitance of signal, e_{driver} is energy of driver cell to make that transition, and e_{driven} is energy related driven cells. If a circuit has transition(0→1) as shown in FIG. 1, the energy weight of N1 is

$${e}_{N1} ( 0 \to 1 ) = \frac{1}{2} {CV}_{DD}^{2} + {e}_{X1} ( 0 \to 1 ) + {e}_{X2} ( 0 \to 1 )$$

The energy values of eₓ₁ (0→1) and eₓ₂ (0→1) can be extracted from power library for that transition. In case of multiple energy tables for the same transition, we take average value of them to cover every case with reasonable error. If the transition is inverted (1→0), the energy weight is

e(1→0)=0+eₓ₁(1→0)+eₓ₂(1→0)

During transition 1 to 0, we can think that there is no charging energy required. The following items show all kinds of the energy weights of a signal.

$${e}_{signal} ( 1 \to 0 ) = {e}_{net} ( 1 \to 0 ) + {e}_{driver} ( 1 \to 0 ) + {e}_{driven} ( 1 \to 0 ) \\ = {e}_{driver} ( 1 \to 0 ) + {e}_{driven} ( 1 \to 0 )$$

$${e}_{signal} ( 0 \to 1 ) = {e}_{net} ( 0 \to 1 ) + {e}_{driver} ( 0 \to 1 ) + {e}_{driven} ( 0 \to 1 ) \\ = \frac{1}{2} {CV}_{DD}^{2} + {e}_{driver} ( 0 \to 1 ) + {e}_{driven} ( 0 \to 1 )$$

$${e}_{signal} ( 0 \to x / z ) = \frac{1}{2} {e}_{signal} ( 0 \to 1 )$$

$${e}_{signal} ( 1 \to x / z ) = \frac{1}{2} {e}_{signal} ( 1 \to 0 )$$

$${e}_{signal} ( x / z \to 1 ) = \frac{1}{2} {e}_{signal} ( 0 \to 1 )$$

$${e}_{signal} ( x / z \to 0 ) = \frac{1}{2} {e}_{signal} ( 1 \to 0 )$$

For the transitions including unknown variable x or z, the proposed method assumes its energy as half of the related full swing energy value.

### 2. GPS(Global Peak Searching) Algorithm: an Efficient Method to Find Global Peaks Using Energy of Each Simulation Time Point

Based on the energy of signal, energy at a certain time point, e(tₙ), could be defined by equation (1)

$$e ( {t}_{n} ) = {\sum }_{i = 0}^{x} {e}_{i} \qquad \{ i \vert i ∈ event signals @ {t}_{n} \}$$

This local time energy addresses the spontaneous current by the events at that time and does not have any correlation information with neighborhood events that occur in near time period. To detect the total energy within near time period, which is called gts (global time step), we define the global peak by equation (2) at time tₘ

$${E}_{m} = {\sum }_{m = {t}_{l}}^{{t}_{n}} e ( m ) \qquad \{ m \vert {t}_{l} \leq m \leq {t}_{n} \}$$

The first procedure of GPS is finding the exact time of the event from VCD, and computing local energy by the events. At the second procedure, GPS sets up gts at the event time and collects all the energy to form the global energy at FIG. 2. gts is extended up and down to the user-defined time or default time (2 nano-second). The third procedure tries to detect global peak by selecting the biggest ones among the global energy. E₂ in FIG. 2, among the global peak values, is obtained at the rank1 period. And Eₙ is rank2. Global peaks enable designers to avoid the local peak like e₆ as shown in FIG. 6.

The detailed procedure is following:

1. Read VCD

2. Push all the time point(t₀, t₁, . . . , tₙ) of VCD to Queue Qₜ

3. If Qₜ is empty, go to 7, otherwise pop tᵢ from Qₜ

4. Calculate event weight of signal at tᵢ

5. Calculate local time weight e(tᵢ) using event weights of signals

6. go to 3

7. Find the boundary of each time point and global weight E(tᵢ)

8. Find K ranks using K-select algorithm

The complexity of 4 and 5 is just

The complexity of 4 and 5 is just O(n) because the proposed algorithm visits time slot only once, n is the number of time point. In procedure 7, we just trace time points twice (forward and backward), and so the complexity is O(2n). Finally, using deterministic K-select algorithm with linear complexity O(n) for 8, the whole complexity of GPS is linear.

1. Definition of energy weight for signal.
In a digital circuit, all the signals are not equal in energy consumption because they have different capacitance, driver cell, driven cells, etc. Therefore, each signal transition needs different energy value when the signal is switching. Our basic idea is to define the energy weight of each signal statistically to estimate relative energy level for catching the most energy consumption regions efficiently.

2. GPS(Global Peak current Searching) algorithm: an efficient method to find global peaks using energy of each simulation time point
After extracting the energy weight of the signals, GPS algorithm computes the energy at each simulation time point by searching the event data, which is called local weight. GPS extracts the global peak that is a summation of local weights within the given period. Then, the global peaks are selected and ranked by well-known K-select algorithm. Global peaks prevent designers from falling in local peaks, which make them have confidence about their peak system power. GPS algorithm improves the analysis speed of applications such as IR-drop analysis dramatically, since the selected regions are sparsely located over the whole simulation periods.
